(19) United States
(12) Patent Application Publication
(10) Pub. No.: US 2004/0183443 A1
(43) Pub. Date: Sep. 23, 2004

(54) Discharge lamp

(75) Inventors: Thomas Bittmann, Friedberg (DE); Alfred Langer, Kissing (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHL, MUNCHEN (DE)

(21) Appl. No.: 10/799,646

(22) Filed: Mar. 15, 2004

(30) Foreign Application Priority Data
Mar. 21, 2003 (DE) 103 12 748.8

(51) Int. Cl. H01J 17/18; H01J 61/36

(52) U.S. Cl. 313/625; 313/623; 313/631

(57) ABSTRACT

The invention relates to a discharge lamp, in particular a high-pressure discharge lamp having a discharge vessel, which has at least one sealed-off end which is provided with a current feedthrough. The section of the electrode which extends into said sealed-off end is provided, according to the invention, with a coating, which contains a high-melting metal from the group of the platinum metals, preferably ruthenium.

### I. TECHNICAL FIELD

The invention relates to a discharge lamp having a discharge vessel, in whose interior an ionizable filling is enclosed in a gas-tight manner, said discharge vessel having at least one sealed-off end which is provided with a current feedthrough, and said at least one current feedthrough being connected to an electrode which protrudes into the interior of the discharge vessel and has a section which extends into said sealed-off end.

### II. BACKGROUND ART

A discharge lamp of this type is disclosed, for example, in the European patent specification EP 0 858 098 B1. This specification describes a metal-halide high-pressure discharge lamp for vehicle headlights having a quartz-glass discharge vessel, in whose interior an ionizable filling is enclosed in a gas-tight manner. The discharge vessel has two sealed-off ends, each having a current feedthrough and an electrode, each electrode being connected to one of the current feedthrough and protruding into the interior of the discharge vessel. The section of the electrodes which is embedded in the quartz glass is surrounded in each case by a coil in order to reduce cracks in the quartz glass.

The laid-open specification EP 1 111 655 A1 describes a molybdenum seal foil for lamp construction, which is provided with a ruthenium-containing coating. This seal foil is part of a current feedthrough, which is arranged in a sealed-off end of a lamp vessel. This foil, which is sealed in the end of the lamp vessel in a gas-tight manner, seals off the lamp vessel. The ruthenium-containing coating makes it possible to produce a better welded joint between the seal foil and the lead-in wires connected to said foil.

### III. DISCLOSURE OF THE INVENTION

It is the object of the invention to provide a generic discharge lamp having improved electrodes. In particular, the intention is to prevent cracks, brought about by the different thermal expansion coefficients of the discharge vessel material and the electrode material and by the adhesion of the discharge vessel material to the electrodes, from forming in the material of the discharge vessel without additional components, such as the coils described in the abovementioned prior art, being used for this purpose.

This object is achieved by a discharge lamp having a discharge vessel, in whose interior an ionizable filling is enclosed in a gas-tight manner, said discharge vessel having at least one sealed-off end which is provided with a current feedthrough, and said at least one current feedthrough being connected to an electrode which protrudes into the interior of the discharge vessel and has a section which extends into said sealed-off end, wherein said section of the electrode which extends into the sealed-off end is provided with a coating, which contains a high-melting metal from the group of the platinum metals.

The discharge lamp according to the invention has a discharge vessel, in whose interior an ionizable filling is enclosed in a gas-tight manner, the discharge vessel having at least one sealed-off end having a current feedthrough, which is connected to an electrode which protrudes into the interior of the discharge vessel and extends into the sealed-off end. The section of the electrode which extends into the sealed-off end is provided, according to the invention, with a coating which contains a high-melting metal from the group of the platinum metals. In this context, high-melting means that the melting temperature of the platinum metals is above the working point of the discharge vessel material which is required for sealing off its ends. Since the discharge vessel of high-pressure discharge lamps usually consists of quartz glass, preferably one of the platinum metals ruthenium, iridium, osmium or rhodium is used for the coating. The coating according to the invention extends at least over part of the surface of the electrode section which protrudes into the sealed-off end or preferably even over the entire surface of the abovementioned electrode section. By providing the section of the electrode which extends into the sealed-off end of the discharge vessel with the abovementioned coating according to the invention, the adhesion between the material of the discharge vessel and the electrode is reduced to such an extent that, as a result of the greater thermal expansion of the electrode compared to the surrounding discharge vessel material, only low mechanical stresses are produced in the sealed-off end of the discharge vessel, which do not result in any damage to the discharge vessel.

Trials have shown that even a coating of the electrode which is only 100 nm thick suffices to reduce the adhesion of the electrode to the glass of the discharge vessel to such an extent that no damage to the discharge vessel is caused by the thermal expansion of the electrode. In accordance with the particularly preferred exemplary embodiment of the invention, the coating consists of ruthenium or a ruthenium alloy, in particular an alloy of ruthenium with the electrode material.

The invention may be used particularly advantageously for discharge lamps whose current feedthroughs must carry a comparatively high current and whose discharge vessel consists of quartz glass. An example of this is metal-halide high-pressure discharge lamps for vehicle headlights and, in particular, mercury-free metal-halide high-pressure discharge lamps. These high-pressure discharge lamps generally have a quartz-glass discharge vessel having sealed-off ends, which have current feedthroughs with molybdenum foil seals. The electrodes of the lamp, which protrude into the discharge space and generally consist of tungsten, are joined to the molybdenum foil seals. The mercury-free metal-halide high-pressure discharge lamps require particularly thick electrodes, since they must carry an even higher current than the conventional metal-halide high-pressure discharge lamps for vehicle headlights. With these lamps, the abovedescribed problem is experienced to an even greater extent than with other high-pressure discharge lamps.

### IV. BRIEF DESCRIPTION OF THE DRAWINGS

The invention is explained in more detail below with reference to a preferred exemplary embodiment. In the drawing:

FIG. 1 shows a schematic representation of a preferred exemplary embodiment of the discharge lamp according to the invention,

FIG. 2 shows a schematic representation of a plan view of a sealed-off end of the discharge vessel of the discharge lamp depicted in FIG. 1 having the corresponding current feedthrough and an electrode,

FIG. 3 shows a plan view of the electrode depicted in FIG. 2, and

FIG. 4 shows a cross section through the electrode depicted in FIG. 3 along the cross-sectional plane A-A.

### V. BEST MODE FOR CARRYING OUT THE INVENTION

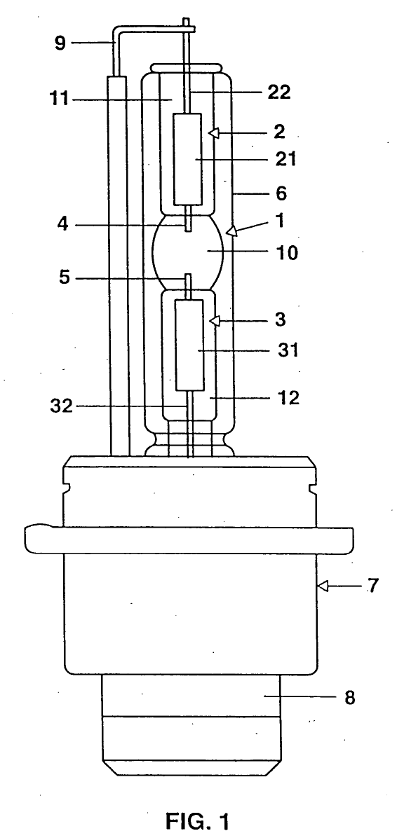

The exemplary embodiment of the invention depicted in FIG. 1 is a mercury-free metal-halide high-pressure discharge lamp having an electrical power consumption of approximately 35 watts. This high-pressure discharge lamp has a quartz-glass discharge vessel 1 having an interior 10 and two diametrically arranged, sealed-off ends 11, 12, which each have a current feedthrough 2, 3. Two diametrically arranged electrodes 4, 5, which are each connected to one of the current feedthroughs 2 and 3, respectively, and between which a gas discharge forms during lamp operation, protrude into the interior 10. In the interior 10 of the discharge vessel 1 is enclosed an ionizable filling, which consists of xenon and two or more metal halides. The discharge vessel 1 is surrounded by an outer bulb 6, which consists of quartz glass, which is provided with dopants absorbing ultraviolet radiation. The lamp also has a plastic base 7, which bears the two lamp vessels 1, 6 and is equipped with the electrical connections 8 of the lamp. The current feedthrough 2 of the end 11 of the discharge vessel 1 which is remote from the base is connected to the first electrical connection 8 via the power return line 9, whilst the other current feedthrough 3 is connected to a second electrical connection (not shown) of the lamp. The entire operating device of the lamp or parts of the operating device, for example the starting apparatus, can be arranged in the lamp base 7.

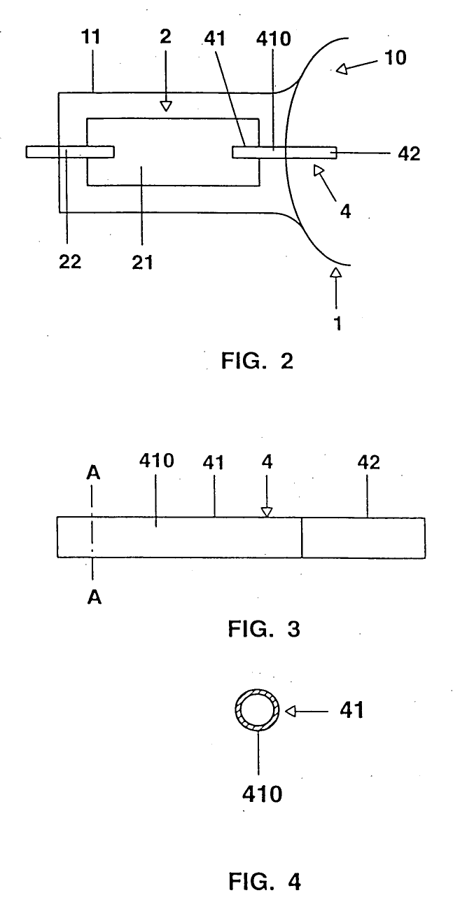

FIG. 2 shows details of the discharge vessel 1 and the current feedthrough 2. The sealed-off ends 11, 12 of the discharge vessel 1 each have a current feedthrough 2, 3. The current feedthroughs 2, 3 each have a molybdenum foil 21 and 31, respectively, which is embedded in a gas-tight manner in the respective end 11 or 12. That side of the respective molybdenum foil 21 or 31 which is remote from the interior 10 of the discharge vessel 1 is welded to a respective molybdenum wire 22 or 32, which protrudes from the corresponding sealed-off end 11 or 12. That side of the respective molybdenum foil 21 or 31 which faces the interior 10 of the discharge vessel 1 is welded to a respective tungsten electrode 4 or 5, in the form of a rod, which protrudes into the discharge space 10. As illustrated schematically in FIGS. 2 to 4, the section 41 of the electrode 4 which extends into the sealed-off end 11 of the discharge vessel 1 is provided with a coating 410, which consists of ruthenium or a ruthenium/tungsten alloy, which can form after coating. Its layer thickness is approximately 500 nm. The length of the electrode 4 is 6.5 mm, and its thickness is 0.33 mm. The section 42 of the electrode 4 which protrudes into the interior 10 of the discharge vessel 1 is not provided with a coating in order to prevent the components of the ionizable filling or the gas discharge taking place within the discharge space from being influenced by ruthenium. The other electrode 5 is of identical construction to the electrode 4.

The invention is not restricted to the exemplary embodiment explained in more detail above. For example, not all of the section 41 of the electrode 4 of 5 which extends into the sealed-off end 11 needs to be provided with the ruthenium layer 410. It is sufficient for only parts of the surface of the electrode which is in contact with the quartz glass to be provided with the ruthenium-containing coating, in order to considerably reduce the risk of cracks forming in the quartz glass.

In addition, the sections of the molybdenum wires 22 or 32 which extend into the sealed-off end 11 or 12 may also be provided with a ruthenium-containing coating, in order to further reduce the risk of cracks forming in the quartz glass.

What is claimed is:

1. A discharge lamp having a discharge vessel, in whose interior an ionizable filling is enclosed in a gas-tight manner, the discharge vessel having at least one sealed-off end which is provided with a current feedthrough, and the at least one current feedthrough being connected to an electrode which protrudes into the interior of said discharge vessel and has a section (41) which extends into sai sealed-off end,
wherein said section of the electrode which extends into said sealed-off end is provided with a coating, which contains a high-melting metal from the group of the platinum metals.

2. The discharge lamp as claimed in claim 1, wherein said coating extends over the entire surface of said section of the electrode which extends into said sealed-off end.

3. The discharge lamp as claimed in claim 1, wherein said high-melting metal from the group of the platinum metals is one of the metals ruthenium, iridium, osmium or rhodium.

4. The discharge lamp as claimed in claim 1, wherein said coating consists of ruthenium or an alloy of the electrode material with ruthenium.

5. The discharge lamp as claimed in claim 1, wherein the thickness of said coating (410) is at least 100 nm.

6. The discharge lamp as claimed in claim 1, wherein said electrode consists of tungsten.

7. The discharge lamp as claimed in claim 1, wherein said discharge vessel consists of quartz glass.

8. A metal-halide high-pressure discharge lamp as claimed in claim 1.
